(19) United States
(12) Patent Application Publication
(10) Pub. No.: US 2021/0325251 A1
(43) Pub. Date: Oct. 21, 2021

(54) IMAGE DISPLAY APPARATUS, IMAGE DISPLAY METHOD, AND STORAGE MEDIUM

(71) Applicant: SINTOKOGIO, LTD., Nagoya-shi (JP)

(72) Inventors: Koki MAEDA, Nagoya-shi (JP); Takashi SUZUKI, Nagoya shi (JP)

(73) Assignee: SINTOKOGIO, LTD., Nagoya-shi (JP)

(21) Appl. No.: 17/227,471

(22) Filed: Apr. 12, 2021

(30) Foreign Application Priority Data
Apr. 17, 2020 (JP) 2020-074317

(51) Int. Cl. G01J 5/02; G06F 3/147; G06F 3/0485; G01K 13/00

(52) U.S. Cl. CPC G01J 5/025; G06F 3/147; G01J 2005/0085; G01K 13/00; G06F 3/0485

(57) ABSTRACT

Provided is an image display apparatus including: a display section configured to display a thermal image in which temperature distribution on a subject is represented by colors, the subject including a pipe or the like for a fluid to flow therein; and a control section configured to control the display section, the control section being configured to control the display section to display the thermal image such that the temperature distribution on the subject is represented by colors within a temperature range having upper and lower limits that are settable.

This Nonprovisional application claims priority under 35 U.S.C. § 119 on Patent Application No. 2020-074317 filed in Japan on Apr. 17, 2020, the entire contents of which are hereby incorporated by reference.

### TECHNICAL FIELD

The present invention relates to an image display apparatus, an image display method, and a storage medium.

### BACKGROUND ART

Patent Literature 1 discloses a pipe clogging diagnosis method by which it is possible to know the degree to which a pipe of a slurry transport line is clogged. The diagnosis method of Patent Literature 1 involves: capturing, with an infrared camera, images that represent transient changes in temperature of the external surface of a slurry pipe; and diagnosing the clogging of the slurry pipe based on thermal images obtained by processing the captured images.

### CITATION LIST

### Patent Literature

[Patent Literature 1]

Japanese Patent Application Publication, Tokukai, No. 2013-83666

### SUMMARY OF INVENTION

### Technical Problem

However, an area in which the diagnosis for clogging of the slurry pipe is carried out by the diagnosis method of Patent Literature 1 (hereinafter “diagnosis area”) is only an area where a temperature sensor such as the infrared camera is provided. Therefore, a user cannot carry out diagnosis in an area other than the area where the temperature sensor is provided.

Furthermore, according to the diagnosis method of Patent Literature 1, if there is an object that greatly differs in temperature from the diagnosis area in the vicinity of the diagnosis area, the temperature range of a thermal image, containing the diagnosis area and the object in the vicinity of the diagnosis area, is set wide to include the temperature of the object. If this is the case, the thermal image does not display slight temperature differences in the diagnosis area, making it impossible to carry out diagnosis in the diagnosis area on the basis of the slight temperature differences in the diagnosis area.

An object of an aspect of the present invention is to provide an image display apparatus, an image display method, and a storage medium each of which makes it possible to display a thermal image containing a desired area of a pipe or the like and each of which makes it possible, even if there is a great difference in temperature between the desired area and its surrounding area, to display slight temperature differences in the desired area in the thermal image.

### Solution to Problem

In order to attain the above object, an image display apparatus in accordance with Aspect 1 of the present invention is an image display apparatus which is portable, including: a display section configured to display a thermal image in which temperature distribution on a subject is represented by colors, the subject including a pipe or the like for a fluid to flow therein; and a control section configured to control the display section, the control section being configured to control the display section to display the thermal image such that the temperature distribution on the subject is represented by colors within a temperature range having upper and lower limits that are settable.

### Advantageous Effects of Invention

An aspect of the present invention makes it possible to display a thermal image containing a desired area of a pipe or the like and, even if there is a great difference in temperature between the desired area and its surrounding area, possible to display slight temperature differences in the desired area in the thermal image.

### BRIEF DESCRIPTION OF DRAWINGS

FIG. 1 illustrates the appearance of an image display apparatus in accordance with Embodiment 1, and is a front view of the image display apparatus.

FIG. 2 illustrates the appearance of the image display apparatus in accordance with Embodiment 1, and is a back view of the image display apparatus.

FIG. 3 is a block diagram illustrating an internal configuration of the image display apparatus in accordance with Embodiment 1.

FIG. 4 illustrates a functional configuration of a control section included in the image display apparatus in accordance with Embodiment 1.

FIG. 5 is a flowchart illustrating operation of the image display apparatus in accordance with Embodiment 1.

FIG. 6 illustrates another functional configuration of the control section included in the image display apparatus in accordance with Embodiment 1.

FIG. 7 shows an example of a screen included in the image display apparatus in accordance with Embodiment 1.

FIG. 8 is a flowchart illustrating another operation of the image display apparatus in accordance with Embodiment 1.

FIG. 9 illustrates a situation in which there is a deposit inside a duct.

FIG. 10 is a chart showing the results obtained by measuring temperatures at respective measurement points on the duct of FIG. 9.

FIG. 11 is a chart showing the results obtained by measuring temperatures at respective measurement points on the duct of FIG. 9.

FIG. 12 shows an example of a screen included in an image display apparatus in accordance with Embodiment 2.

### DESCRIPTION OF EMBODIMENTS

### Embodiment 1

(1-1. Overview)

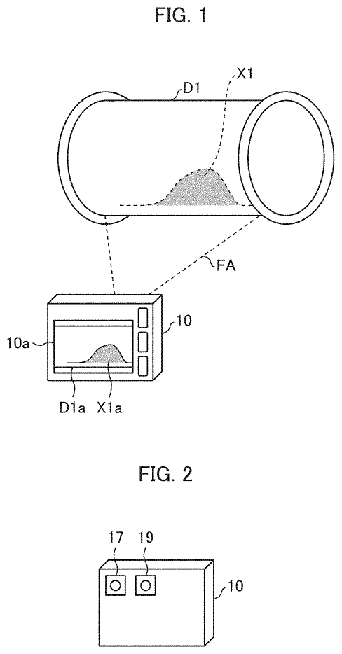

FIGS. 1 and 2 illustrate the appearance of an image display apparatus 10 in accordance with Embodiment 1 of the present invention. FIG. 1 is a front view of the image display apparatus 10. FIG. 2 is a back view of the image display apparatus 10. As illustrated in FIGS. 1 and 2, the image display apparatus 10 is a wireless terminal that can be carried around by a user (i.e., portable). The image display apparatus 10 is, for example, a mobile phone, a smartphone, a tablet computer, or a laptop personal computer. As illustrated in FIG. 1, the image display apparatus 10 has a screen 10a on its front side. As illustrated in FIG. 2, the image display apparatus 10 has a visible-light camera 17 and an infrared camera 19 on its back side.

The visible-light camera 17 is a camera that is sensitive to wavelength(s) in the visible wavelength range and that captures a visible light image by detecting visible light from a subject. The infrared camera 19 is a camera that is sensitive to wavelength(s) in the infrared wavelength range and that captures an infrared image by detecting infrared light from a subject. The field-of-view of the visible-light camera 17 and the field-of-view of the infrared camera 19 substantially coincide with each other. In the example illustrated in FIG. 1, the field-of-view of the visible-light camera 17 and the field-of-view of the infrared camera 19 are both “field-of-view FA”. The image display apparatus 10 is a wireless terminal that can be carried around by a user; therefore, the user can move to a desired place and direct the field-of-view FA of the visible-light camera 17 and the infrared camera 19 in a desired direction.

FIG. 1 shows an example of the manner in which the image display apparatus 10 captures an image of a duct D1. The duct D1 is, for example, a pipe or the like for a fluid to flow and travel therein. The term “fluid” is a generic term for liquid and gas. The pipe or the like can be, for example, a duct, a damper, or a device that uses fluid energy. The duct D1 is, for example, installed in a building such as a steel plant for the purpose of air conditioning, ventilation, smoke exhaustion, or the like. The duct D1 is an example of the “pipe or the like”. A part of the appearance of the duct D1 which part is included in the foregoing field-of-view FA is an example of the subject whose image is to be captured by the image display apparatus 10. Note that the field-of-view FA may include an environment surrounding the duct D1 (hereinafter “surrounding environment”), in addition to the duct D1.

The surrounding environment is, for example, an environment in which a support member supports the duct D1 and/or an environment in which an apparatus is disposed in the vicinity of the duct D1 when viewed from the image display apparatus 10. In this case, the subject also includes such a surrounding environment.

In the example illustrated in FIG. 1, the duct D1 has therein a deposit X1, which is made of dust settled and accumulated on the inner wall of the duct D1. Heat transfer from the fluid flowing within the duct D1 to the deposit X1 and that from the fluid to the inner wall of the duct D1 are different from each other, and therefore the manner in which heat is drawn to the deposit X1 and the manner in which heat is drawn to the inner wall of the duct D1 are different from each other. This results in a difference in temperature, at the surface of the duct D1, between (i) a part of the surface which part opposes an inner wall where the deposit X1 is present, and an area surrounding that part, and (ii) the remainder of the surface, i.e., an area except for that part of the surface and the surrounding area. The image display apparatus 10 observes this difference in temperature with use of the infrared camera 19, thereby detecting a boundary between the above areas (i) and (ii). The user identifies the presence of the deposit X1 on the basis of the presence of the detected boundary.

In the example illustrated in FIG. 1, the image display apparatus 10 causes the screen 10a to display a visible light image captured by the visible-light camera 17 and a thermal image based on an infrared image captured by the infrared camera 19 such that the visible light image and the thermal image are superimposed. The screen 10a displays (i) a duct image D1a that is contained in the visible light image and (ii) a deposit image X1a that is contained in the thermal image. The duct image X1a is an image corresponding to the duct D1. The deposit image X1a is an image corresponding to the deposit X1. The user can see the deposit image X1a contained in the thermal image and the duct image D1a contained in the visible light image together. This allows the user to easily recognize the position of the deposit image X1a.

(1-2. Configuration)

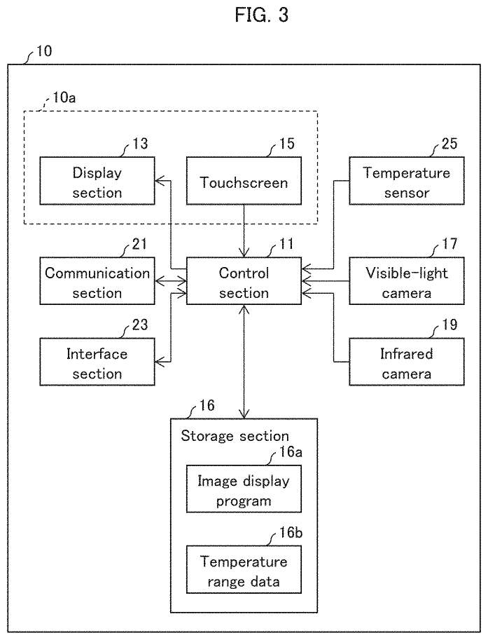

FIG. 3 is a block diagram illustrating an internal configuration of the image display apparatus 10. The image display apparatus 10 includes: a control section 11 that carries out overall control of operation of the image display apparatus 10; a display section 13 that displays various types of information; a touchscreen 15 via which a user can perform operations; a storage section 16 that stores data and programs; a communication section 21 for connection with a network; and an interface section 23 for connection with an external apparatus. The image display apparatus 10 further includes the visible-light camera 17 and the infrared camera 19, as described earlier. The image display apparatus 10 may include a temperature sensor 25.

It is noted here that, in Embodiment 1, the visible light image captured by the visible-light camera 17 is not essential to the image display apparatus 10. In Embodiment 1, the image display apparatus 10 does not necessarily need to use the visible light image captured by the visible-light camera 17. In Embodiment 1, a configuration in which the image display apparatus 10 includes the infrared camera 19 but does not include the visible-light camera 17 may be employed.

The display section 13 is composed of, for example, a liquid crystal display or an organic light emitting display. The touchscreen 15 is, for example, an input device that detects a user's finger or a stylus pen touching the touchscreen 15. The touchscreen 15 is disposed such that its area for operation is superimposed on a display area of the display section 13. The screen 10a in FIG. 1 includes the display section 13 and the touchscreen 15.

The communication section 21 is a device for connection with a network (not illustrated). The communication section 21 communicates with the network in accordance with a communication standard such as 3G, 4G, or LTE. The interface section 23 is a device for connection with an external apparatus (not illustrated). The interface section 23 carries out communication in accordance with a communication standard such as USB (registered trademark), HDMI (registered trademark), or Bluetooth (registered trademark).

The storage section 16 is a storage medium that stores parameters, data, control programs, and/or the like for use in implementing a predetermined function. The storage section 16 is composed of, for example, a hard disk, a semiconductor storage, or a semiconductor memory.

The storage section 16 stores an image display program 16a and temperature range data 16b which are for implementing a function of the image display apparatus 10 (such a function will be described later). The image display program 16a is an example of a control program. The temperature range data 16b is used to set the upper and lower limits of a temperature range for use in generating a thermal image from an infrared image captured by the infrared camera 19.

The control section 11 includes a CPU. The control section 11 executes the image display program 16a to implement the function of the image display apparatus 10 (the function will be described later). Note that the control section 11 may be realized only by a hardware circuit designed especially for implementation of a specific function. The control section 11 may also include various circuits such as MPU, GPU, DSP, FPGA, ASIC, and/or the like in addition to the CPU.

(1-3. Operation)

As described earlier, in Embodiment 1, the visible light image captured by the visible-light camera 17 is not essential to the image display apparatus 10. The following description will first discuss Embodiment 1 based on an example configuration in which the image display apparatus 10 does not use the visible light image captured by the visible-light camera 17, and then discuss Embodiment 1 based on an example configuration in which the image display apparatus 10 uses the visible light image captured by the visible-light camera 17.

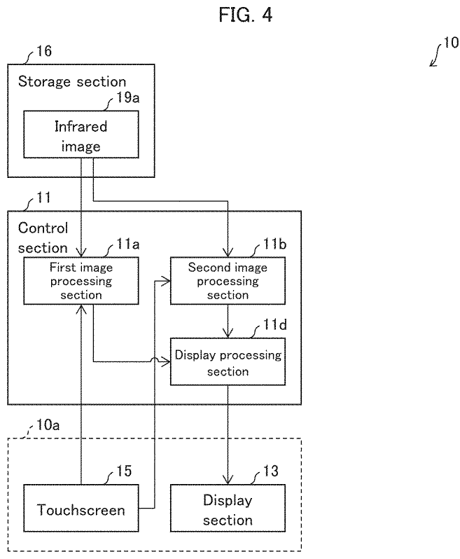

FIG. 4 illustrates a functional configuration of the control section 11. The example illustrated in FIG. 4 is a configuration in which the image display apparatus 10 does not use the visible light image captured by the visible-light camera 17. The control section 11 includes a first image processing section 11a, a second image processing section 11b, and a display processing section 11d. The processing sections 11a, 11b, and 11d included in the control section 11 are realized by the control section 11 executing the image display program 16a.

The following description will discuss operation in the case of the example illustrated in FIG. 4.

The image display apparatus 10 has the function of causing the display section 13 to display a thermal image based on an infrared image captured by the infrared camera 19. The “thermal image” herein means an image which is generated from an infrared image and in which each pixel is colored according to temperature information indicative of the temperature of a part of a subject included in that pixel. The color of each pixel is set within a temperature range having upper and lower limits set. This makes it possible to generate a thermal image in which temperature distribution on the subject is represented by colors within the foregoing temperature range. This function of displaying an image is realized by the control section 11 executing the image display program 16a.

Note that the color of each pixel may be set such that at least one of the three components of color (i.e., “hue”, “saturation”, and “lightness”) varies depending on the temperature of that pixel. For example, the “saturation” and “lightness” may be varied with the “hue” fixed. Alternatively, the “hue” may be varied with the “saturation” and “lightness” fixed. The following description will discuss an example embodiment in which the “hue” is varied with the “saturation” and “lightness” fixed.

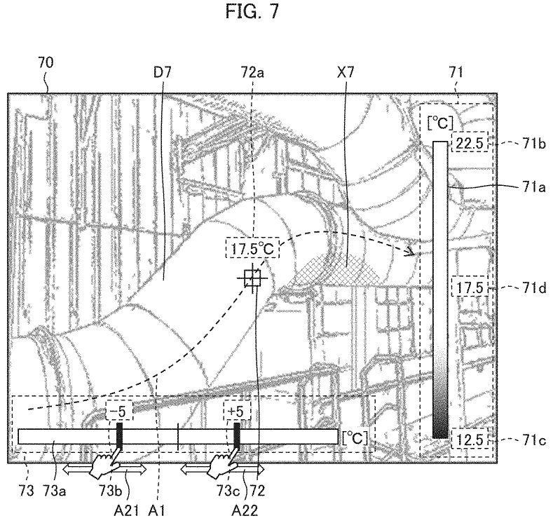

FIG. 7 shows an example of the screen 10a in which a visible light image and a thermal image are displayed by the image display apparatus 10. As shown in FIG. 7, a screen example 70 (an example of the screen 10a) displays (i) a visible light image of a duct D7 and its surrounding environment and (ii) a thermal image generated from an infrared image of the duct D7 and its surrounding environment such that the visible light image and the thermal image are superimposed. The thermal image is an image which is generated from the infrared image by changing the hue of each pixel included in the infrared image in accordance with temperature information on that pixel. Note that the duct D7 is an example of the “pipe or the like”. Also note that the duct D7 and its surrounding environment are an example of the “subject”. Further note that a fluid flows within the duct D7 in the direction indicated by arrow A1.

It is noted here that, in the example shown in FIG. 7, the visible light image of the duct D7 and its surrounding environment and the thermal image of the duct D7 and its surrounding environment are displayed such that they are superimposed; however, the following description is based on the assumption that the thermal image of the duct D7 and its surrounding environment only is displayed in FIG. 7.

The screen example 70 in FIG. 7 displays, in an area 71, a color bar 71a such that the color bar 71a is superimposed on the thermal image. The screen example 70 in FIG. 7 displays, in an area 73, a slide bar 73a such that the slide bar 73a is superimposed on the thermal image. In particular, the slide bar 73a is a user interface on which a user carries out touch gestures such as swiping. This allows the user to carry out operations in an intuitive manner.

The screen example 70 in FIG. 7 also displays a reference position mark 72 such that the reference position mark 72 is superimposed on the thermal image. The reference position mark 72 is present at, for example, the center of the screen 10a. For example, in order to have the reference position mark 72 located at the internal central portion of the duct D7, a user need only direct the center of the field-of-view FA of the image display apparatus 10 in the direction toward the internal central portion of the duct D7. Note that the reference position mark 72 does not necessarily need to be present at the center of the screen 10a. The reference position mark 72 may be present at or near the upper right corner of the screen 10a or at or near the lower left corner of the screen 10a, for example. The position of the reference position mark 72 may be pre-set or may be set as appropriate by a user.

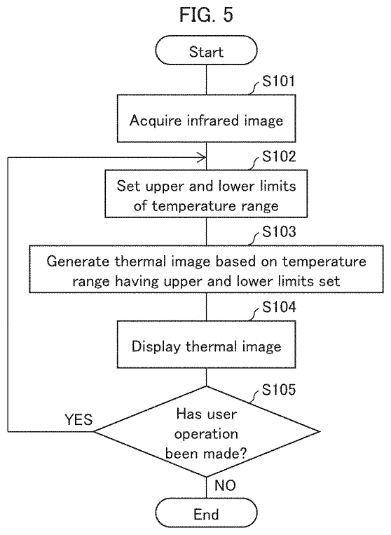

The following description will discuss how the image display apparatus 10 operates, with reference to the screen example 70 of FIG. 7 and with reference to FIG. 5. FIGS. 3 and 4 are also referenced as necessary.

FIG. 5 is a flowchart illustrating operation in the case of the example shown in FIG. 4. The flowchart of FIG. 5 is for the case in which the image display apparatus 10 is configured not to use the visible light image captured by the visible-light camera 17.

Step S101:

The control section 11 acquires an infrared image 19a of a duct D7 and its surrounding environment, captured by the infrared camera 19. The control section 11 causes the storage section 16 to store the infrared image 19a acquired from the infrared camera 19.

Step S102:

The first image processing section 11a of the control section 11 reads the infrared image 19a from the storage section 16. The first image processing section 11a acquires temperature information on each pixel included in the read infrared image 19a. The first image processing section 11a sets a reference temperature, with use of the temperatures of pixels which are included in the infrared image 19a and which correspond to the reference position mark 72 and its surrounding area. In a case where the temperatures of the pixels are different, the average of the temperatures of the pixels may be used as the reference temperature.

The first image processing section 11a sets the upper and lower limits of the foregoing temperature range with use of the set reference temperature and pre-set range values. In the screen example 70 of FIG. 7, the reference temperature (temperature indicated at the location of the reference position mark 72) is “17.5° C.”. The range values are “±5° C.”. The range values “±5° C.” are default values. The value “+5° C.” of the range values “±5° C.” is the upper range value. The value “−5° C.” of the range values “±5° C.” is the lower range value. The range values are represented by sliders on the slide bar 73a. A user can change the range values as desired by, for example, swiping, which is a kind of touch gesture.

The first image processing section 11a sets the upper and lower limits of the temperature range using the following equations:

Upper limit=17.5° C.+5° C.=22.5° C., and

Lower limit=17.5° C.−5° C.=12.5° C.

The first image processing section 11a allocates hue to each temperature included in the temperature range having the upper and lower limits set. The first image processing section 11a generates an image of the color bar 71a which reflects the hues allocated to respective temperatures. The image of the color bar 71a is, for example, an image that changes in color in the order of “blue”, “green”, and “red” with increasing distance from the lower limit and with decreasing distance to the upper limit. The first image processing section 11a refers to the temperature range data 16b stored in the storage section 16 to decide which hue is to be allocated to each temperature. The hues allocated to respective temperatures are, for example, stored as part of the temperature range data 16b in the storage section 16. The hues allocated to respective temperatures can be rewritten by a user anytime.

Note that, as shown in FIG. 7, there is a temperature display area 72a indicating “17.5° C.”, displayed above the reference position mark 72. As shown in FIG. 7, there are a lower range value display area 73b indicating “−5” and an upper range value display area 73c indicating “+5”, displayed above the slide bar 73a. The upper range value, which is the upper one of the range values, and the lower range value, which is the lower one of the range values, are, for example, stored as part of the temperature range data 16b in the storage section 16. The range values can be rewritten by a user anytime.

Furthermore, as shown in FIG. 7, there is an upper limit display area 71b indicating “22.5”, displayed near the top end of the color bar 71a. There is a lower limit display area 71c indicating “12.5”, displayed near the bottom end of the color bar 71a. There is a reference temperature display area 71d indicating “17.5”, displayed near the middle of the color bar 71a.

Note that the positions of the display areas 71b, 71c, 71d, 72a, 73b, and 73c shown in FIG. 7 are mere examples, and therefore the positions of the display areas 71b, 71c, 71d, 72a, 73b, and 73c are not limited to those shown in FIG. 7. Also note that the display areas 71b, 71c, 71d, 72a, 73b and 73c do not necessarily need to be displayed.

The first image processing section 11a generates images that are used to display the color bar 71a, the reference position mark 72, the slide bar 73a, and the display areas 71b, 71c, 71d, 72a, 73b, and 73c on the screen 10a, respectively.

Step S103:

The second image processing section 11b of the control section 11 sets a reference temperature and upper and lower limits. A process of setting these is the same as in the case of the first image processing section 11a, and therefore descriptions therefor are not repeated here.

The second image processing section 11b reads the infrared image 19a from the storage section 16. The second image processing section 11b generates, from the read infrared image 19a, a thermal image in which temperature distribution on the duct D7 and its surrounding environment is represented by colors within the temperature range having the upper and lower limits set. Specifically, the second image processing section 11b refers to the temperature range data 16b stored in the storage section 16 to decide the color of each pixel of the infrared image 19a on the basis of the temperature of that pixel. The second image processing section 11b generates a thermal image in which each pixel is colored according to the temperature of that pixel.

In the example shown in FIG. 7, a part of the surface of the duct D7, which part differs in temperature from its surrounding area due to the presence of a deposit X7, is colored differently from the surrounding area.

Step S104:

The first image processing section 11a outputs, to the display processing section 11d, the images that are used to display the color bar 71a, the reference position mark 72, the slide bar 73a, and the display areas 71b, 71c, 71d, 72a, 73b, and 73c on the screen 10a, respectively. The second image processing section 11b outputs the thermal image to the display processing section 11d.

The display processing section 11d causes the screen 10a to display the images inputted from the first image processing section 11a and the second image processing section 11b such that the images from the first image processing section 11a are superimposed on the thermal image from the second image processing section 11b.

Step S105:

The image display apparatus 10 stops operating if no user operation has been received via the touchscreen 15 (NO in step S105).

On the contrary, if a user operation has been received via the touchscreen 15 (YES in step S105), the control section 11 carries out step S102 again.

Specifically, as shown in FIG. 7, the user slides sliders on the slide bar slide bar 73a with his/her finger or a stylus pen along a direction indicated by arrow A21 or along a direction indicated by arrow A22. The touchscreen 15 detects the amount by which each slider has been slid and the direction in which each slider has been slid by the user's finger or the stylus pen. The first image processing section 11a and the second image processing section 11b decide, in accordance with the amounts of sliding detected by the touchscreen 15, the amount by which the current upper range value is to be changed and the amount by which the current lower range value is to be changed. The first image processing section 11a and the second image processing section 11b also decide, in accordance with the directions of sliding detected by the touchscreen 15, whether the upper range value is to be increased or reduced and whether the lower range value is to be increased or reduced. The first image processing section 11a and the second image processing section 11b change the current upper range value and the current lower range value in accordance with such decisions (the amounts by which the upper range value and the lower range value are to be changed and whether the upper range value and the lower range value are to be increased or reduced).

Note that the user can change only one of the current upper and lower range values by sliding only one of the sliders on the slide bar 73a with his/her finger or a stylus pen along the direction indicated by arrow A21 or along the direction indicated by arrow A22.

Then, the first image processing section 11a and the second image processing section 11b set the upper and lower limits of the temperature range on the basis of the upper and lower range values at least one of which has been changed. Then, the foregoing steps S102 to S105 are repeated.

The user can change the foregoing upper and lower limits by a simple action while checking the thermal image displayed on the screen 10a. Since a thermal image with a temperature range having upper and lower limits freely set by the user is displayed, a user-friendly method is provided.

A typical infrared camera automatically recognizes the highest and lowest temperatures in the captured image. The infrared camera allocates a hue to each temperature included in the temperature range defined by the recognized highest and lowest temperatures. For example, if there is an object that differs greatly in temperature from its surroundings in the captured image, the infrared camera automatically recognizes the temperature of the object as the lowest or highest temperature. Therefore, in an area that the user wants to examine, hue varies in large steps, and therefore it is impossible to represent slight differences in temperature. The user cannot recognize the slight differences in temperature from such variations in hue.

With the image display apparatus 10, in a case where there is an object that differs greatly in temperature from its surroundings in the captured image, the user can change the foregoing upper and lower limits by a simple action so that the temperature of the object is out of the temperature range. With this, the user can cause a slight temperature difference, in the area that the user wants to examine, to be displayed in a thermal image with a temperature range having the changed upper and lower limits.

The following description will discuss Embodiment 1 based on an example configuration in which the image display apparatus 10 uses the visible light image captured by the visible-light camera 17.

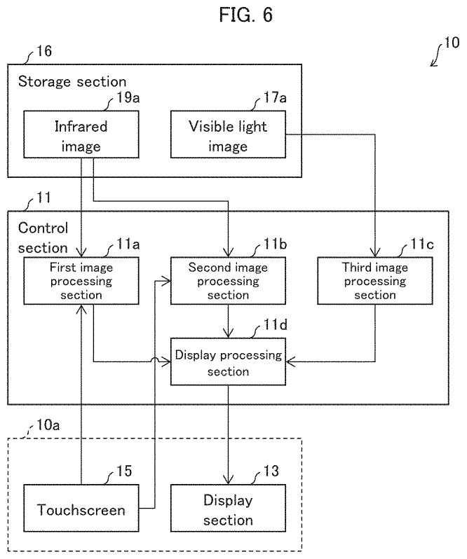

FIG. 6 illustrates another functional configuration of the control section 11. The example illustrated in FIG. 6 is a configuration in which the image display apparatus 10 uses the visible light image captured by the visible-light camera 17. The control section 11 includes the first image processing section 11a, the second image processing section 11b, a third image processing section 11c, and the display processing section 11d. The processing sections 11a, 11b, 11c, and 11d included in the control section 11 are realized by the control section 11 executing the image display program 16a.

The following description will discuss operation in the case of the example illustrated in FIG. 6. Note that members having functions identical to those described with reference to the example of FIG. 4 are assigned identical referential numerals, and their descriptions are not repeated here.

The image display apparatus 10 has the function of causing the display section 13 to display (i) a thermal image based on an infrared image captured by the infrared camera 19 and (ii) a visible light image captured by the visible-light camera 17 such that the visible light image is superimposed on the thermal image. This function of displaying images is realized by the control section 11 executing the image display program 16a.

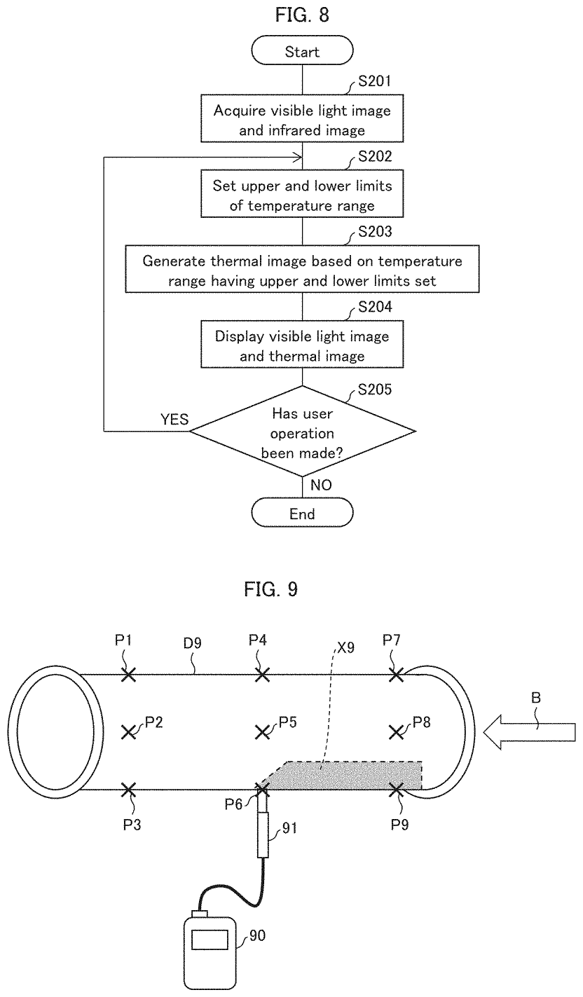

The following description will discuss how the image display apparatus 10 operates, with reference to the screen example 70 of FIG. 7 and with reference to FIG. 8. FIGS. 3 and 6 are also referenced as necessary.

FIG. 8 is a flowchart illustrating operation in the case of the example shown in FIG. 6. The flowchart of FIG. 8 is for the case in which the image display apparatus 10 is configured to use the visible light image captured by the visible-light camera 17.

Step S201:

The control section 11 acquires a visible light image 17a of a duct D7 and its surrounding environment, captured by the visible-light camera 17. The control section 11 further acquires an infrared image 19a of the duct D7 and its surrounding environment, captured by the infrared camera 19. The control section 11 causes the storage section 16 to store the visible light image 17a acquired from the visible-light camera 17 and the infrared image 19a acquired from the infrared camera 19.

Step S202:

Step S202 is the same as step S102 of FIG. 5, and therefore descriptions therefor are not repeated here.

Step S203:

Step S202 is the same as step S103 of FIG. 5, and therefore descriptions therefor are not repeated here.

Step S204:

The first image processing section 11a outputs, to the display processing section 11d, the images that are used to display the color bar 71a, the reference position mark 72, the slide bar 73a, and the display areas 71b, 71c, 71d, 72a, 73b, and 73c on the screen 10a, respectively. The second image processing section 11b outputs the thermal image to the display processing section 11d. The third image processing section 11c reads the visible light image 17a from the storage section 16. The third image processing section 11c outputs the read visible light image 17a to the display processing section 11d.

The display processing section 11d causes the screen 10a to display the images inputted from the first image processing section 11a, the second image processing section 11b, and the third image processing section 11c such that the images from the first image processing section 11a are superimposed on the thermal image from the second image processing section 11b and the visible light image from the third image processing section 11c. In the screen example 70 of FIG. 7, an image of the duct D7 included in the visible light image and an image of a deposit X7 included in the thermal image are superimposed. This allows the user to easily determine the position of the deposit X7.

Step S205:

Step S205 is the same as step S105 of FIG. 5, and therefore descriptions therefor are not repeated here.

### Embodiment 2

The following description will discuss Embodiment 2 of the present invention. For convenience of description, members having functions identical to those described in Embodiment 1 are assigned identical referential numerals, and their descriptions are not repeated here.

Embodiment 2 is different from Embodiment 1 in that the foregoing upper and lower limits are automatically set on the basis of the surface temperature of a duct and the temperature of an environment surrounding the duct, instead of setting the upper and lower limits on the basis of the reference temperature and range values. The following description will discuss this difference.

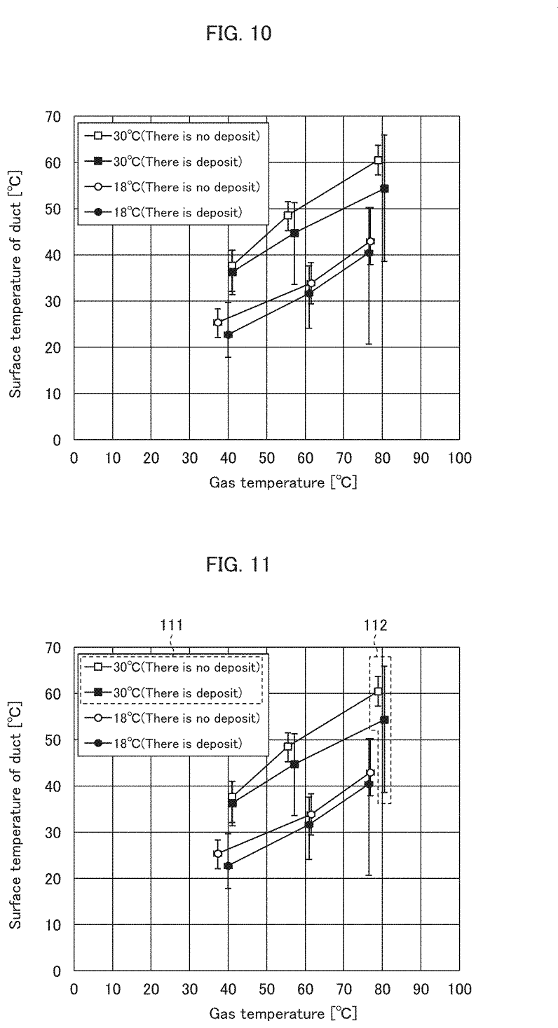

The inventors of the present invention have found that the foregoing upper and lower limits can be set on the basis of the relationship between the surface temperature of the duct and the temperature of the environment surrounding the duct (hereinafter may be referred to as “ambient temperature”). This relationship is discussed with reference to FIGS. 9 and 10. FIG. 9 illustrates a situation in which a fluid flows within a duct D9 in the direction indicated by arrow B and in which there is a deposit X9 inside the duct D9. In the example shown in FIG. 9, a measuring section 91 of a temperature measuring device 90 was brought into contact with each of measurement points P1 to P9 on the surface of the duct D9 and the temperatures at the respective measurement points were measured. FIG. 10 shows the results of the measurement.

Note that the duct D9 was made of iron, and that the deposit X9 was a deposit of iron fume. Also note that the measurement was carried out under the conditions in which the ambient temperature was 18° C. and under the conditions in which the ambient temperature was 30° C., while the fluid temperature was varied within the range of 40° C. to 80° C.

The results of the measurement shown in FIG. 10 demonstrate the following, concerning the temperature distribution on the surface of the duct D9.
Measurement points where deposit X9 is not present: Temperature distribution is within the range of about ±5° C. of the average of the temperatures at the measurement points.
Measurement points where deposit X9 is present: Temperature distribution widens in the negative direction as compared to the temperature distribution at the measurement points where the deposit X9 is not present.

The following conclusion was derived from the above-stated two findings.
The maximum value of the temperature distribution is substantially the same between the measurement points where the deposit X9 is not present and the measurement points where the deposit X9 is present.

In Embodiment 2, the storage section 16 pre-stores an experimental fact indicative of the degree of temperature distribution which has resulted from a certain surface temperature of the duct D9 and a certain temperature of the environment surrounding the duct D9. The experimental fact is an example of “relationship information”. In the example shown in FIG. 11, it can be said that, when the temperature at the internal central portion of the duct D9 is 60° C. and the temperature of the environment surrounding the duct D9 is 30° C. (see the legends enclosed by dashed line 111 in FIG. 11), the temperature distribution on the surface of the duct D9 can range from 40° C. to 65° C. (see the graph enclosed by dashed line 112 in FIG. 11). In the example shown in FIG. 11, the following fact corresponds to the experimental fact: when the temperature at the internal central portion of the duct D9 is 60° C. and the temperature of the environment surrounding the duct D9 is 30° C., the temperature distribution on the surface of the duct D9 can range from 40° C. to 65° C. Note that the temperature at the internal central portion of the duct D9 means the temperature set on the basis of the temperatures of respective pixels in an infrared image superimposed on the internal central portion of the duct D9. Further note that the charts shown in FIGS. 10 and 11 are identical to each other.

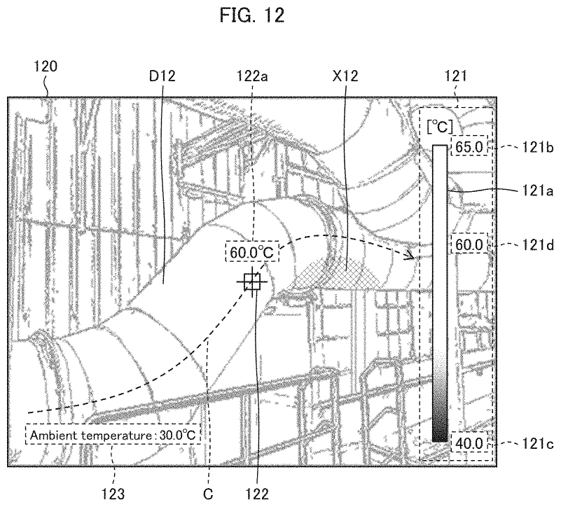

FIG. 12 shows an example of the screen 10a in which a visible light image and a thermal image are displayed by the image display apparatus 10. As shown in FIG. 12, a screen example 120 (an example of the screen 10a) displays (i) a visible light image of a duct D12 and its surrounding environment and (ii) a thermal image generated from an infrared image of the duct D12 and its surrounding environment such that the visible light image and the thermal image are superimposed. The thermal image is an image which is generated from the infrared image by changing the hue of each pixel included in the infrared image in accordance with temperature information on that pixel. Note that the duct D12 is an example of the “pipe or the like”. Also note that the duct D12 and its surrounding environment are an example of the “subject”. Further note that a fluid flows within the duct D12 in the direction indicated by arrow C.

The screen example 120 in FIG. 12 displays, in an area 121, a color bar 121a such that the color bar 121a is superimposed on the visible light image and the thermal image.

The screen example 120 in FIG. 12 also displays a reference position mark 122 such that the reference position mark 122 is superimposed on the visible light image and the thermal image. The reference position mark 122 is present at, for example, the center of the screen 10a. For example, in order to have the reference position mark 122 located at the internal central portion of the duct D12, a user need only direct the center of the field-of-view FA of the image display apparatus 10 in the direction toward the internal central portion of the duct D12. Note that the reference position mark 122 does not necessarily need to be present at the center of the screen 10a. The reference position mark 122 may be present at or near the upper right corner of the screen 10a or at or near the lower left corner of the screen 10a, for example. The position of the reference position mark 122 may be pre-set or may be set as appropriate by a user.

Furthermore, as shown in FIG. 12, there is a temperature display area 122a indicating “60.0° C.”, displayed above the reference position mark 122. As shown in FIG. 12, there is an ambient temperature display area 123 indicating “ambient temperature: “30.0° C.”, displayed near the lower left corner of the screen example 120. The ambient temperature may be acquired from, for example, the temperature sensor 25. The ambient temperature may be the average of the temperatures of respective pixels in the environment surrounding the duct D12 in the infrared image captured by the infrared camera 19, i.e., the pixels in the infrared image excluding the duct D12.

Furthermore, as shown in FIG. 12, there is an upper limit display area 121b indicating “65.0”, displayed near the top end of the color bar 121a. There is a lower limit display area 121c indicating “40.0”, displayed near the bottom end of the color bar 121a. There is a reference temperature display area 121d indicating “60.0° C.”, displayed between the upper limit display area 121b and the lower limit display area 121c. The upper limit “65.0” (° C.) shown in the upper limit display area 121b and the lower limit “40.0” (° C.) shown in the lower limit display area 121c are values which have been automatically set by the image display apparatus 10 by referring to the foregoing experimental fact and on the basis of the surface temperature “60.0° C.” of the duct D12 shown in the temperature display area 122a and the ambient temperature “30.0° C.” shown in the ambient temperature display area 123. Note that, in the example shown in FIG. 12, the surface temperature “60.0° C.” is the temperature at the internal central portion of the duct D12.

Note that the positions of the display areas 121b, 121c, 121d, 122a, and 123 shown in FIG. 12 are mere examples, and therefore the positions of the display areas 121b, 121c, 121d, 122a, and 123 are not limited to those shown in FIG. 12. Also note that the display areas 121b, 121c, 121d, 122a, and 123 do not necessarily need to be displayed.

Also in Embodiment 2, range values may be pre-set similarly to Embodiment 1. In this case, in the example shown in FIG. 12, the slide bar 73a shown in FIG. 7 is further displayed. The user can change the current upper and lower range values by sliding the sliders on the slide bar 73a with his/her finger or a stylus pen. The user can set the upper and lower limits of the temperature range again by changing the upper range value and/or the lower range value, similarly to Embodiment 1. Note that, in the example shown in FIG. 12, the surface temperature “60.0° C.” of the duct D12 shown in the temperature display area 122a is the reference temperature in accordance with Embodiment 1. In a case where the slide bar 73a of FIG. 7 is displayed in the example shown in FIG. 12, the position of the slide bar 73a does not necessarily need to correspond to the area 73 of FIG. 7. The slide bar 73a may be displayed, for example, near the upper left corner or near the bottom center of the screen example 120 shown in FIG. 12.

[Software Implementation Example]

The control section 11 of the image display apparatus 10 can be realized by a logic circuit (hardware) provided in an integrated circuit (IC chip) or the like or can be alternatively realized by software.

In the latter case, the control section 11 includes a computer that executes instructions of a program that is software realizing the foregoing functions. The computer, for example, includes at least one processor and at least one computer-readable storage medium storing the program. An object of the present invention can be achieved by the processor of the computer reading and executing the program stored in the storage medium. Examples of the processor encompass a central processing unit (CPU). Examples of the storage medium encompass a “non-transitory tangible medium” such as a read only memory (ROM), a tape, a disk, a card, a semiconductor memory, and a programmable logic circuit. The computer may further include a random access memory (RAM) or the like in which the program is loaded. Further, the program may be supplied to or made available to the computer via any transmission medium (such as a communication network and a broadcast wave) which allows the program to be transmitted. Note that an aspect of the present invention can also be achieved in the form of a computer data signal in which the program is embodied via electronic transmission and which is embedded in a carrier wave.

Aspects of the present invention can also be expressed as follows:

An image display apparatus in accordance with Aspect 1 of the present invention is an image display apparatus which is portable, including: a display section configured to display a thermal image in which temperature distribution on a subject is represented by colors, the subject including a pipe or the like for a fluid to flow therein; and a control section configured to control the display section, the control section being configured to control the display section to display the thermal image such that the temperature distribution on the subject is represented by colors within a temperature range having upper and lower limits that are settable.

With the configuration, a user can carry around the image display apparatus, and therefore it is possible to cause the image display apparatus to display a thermal image including a desired area of the pipe or the like.

Furthermore, with the configuration, even if there is a great difference in temperature between the desired area and an area surrounding the desired area, is it possible, by setting the upper and lower limits of the temperature range, to display slight temperature differences in the desired area in the thermal image.

In Aspect 2 of the present invention, an image display apparatus in accordance with Aspect 1 is arranged such that the control section is configured to control the display section to display the thermal image such that the temperature distribution on the subject is represented by variations in at least one of (i) hue, (ii) saturation, and (iii) lightness.

With the configuration, it is possible to present, to a user, the temperature distribution on the subject represented by variations in at least one of (i) hue, (ii) saturation, and (iii) lightness.

In Aspect 3 of the present invention, an image display apparatus in accordance with Aspect 1 or 2 is arranged such that the control section is configured to control the display section such that, when at least one of the upper and lower limits of the temperature range has been changed, the display section displays the thermal image such that the temperature distribution on the subject is represented by colors within the temperature range in which the at least one of the upper and lower limits has been changed.

With the configuration, it is possible to present, to a user, the temperature distribution on the subject represented by colors within the changed temperature range.

In Aspect 4 of the present invention, an image display apparatus in accordance with any of Aspects 1 to 3 is arranged such that: the display section includes a screen in which the thermal image is displayed; and the control section is configured to set the upper and lower limits of the temperature range using, as a reference temperature, a temperature which is obtained from the thermal image and which is indicated at a predetermined position on the screen.

With the configuration, it is possible to set the upper and lower limits on the basis of the temperature indicated at a predetermined position on the screen.

In Aspect 5 of the present invention, an image display apparatus in accordance with Aspect 4 is arranged such that: the subject further includes an environment which surrounds the pipe or the like; and the control section is configured to set the upper and lower limits of the temperature range in accordance with relationship information pre-stored in the image display apparatus, the relationship information being indicative of a relationship between a surface temperature of the pipe or the like and a temperature of the environment.

With the configuration, it is possible to set the upper and lower limits on the basis of the surface temperature of the pipe or the like and the temperature of the environment.

In Aspect 6 of the present invention, an image display apparatus in accordance with any of Aspects 1 to 5 is arranged such that: the control section is configured to control the display section to further display a slide bar such that the slide bar is superimposed on the thermal image, the slide bar being a user interface via which the upper and lower limits of the temperature range are set; (i) an amount by which the upper limit of the temperature range is to be changed is decided in accordance with an amount by which a first slider on the slide bar has been slid and (ii) an amount by which the lower limit of the temperature range is to be changed is decided in accordance with an amount by which a second slider on the slide bar has been slid; and (a) whether the upper limit of the temperature range is to be increased or reduced is decided in accordance with a direction in which the first slider on the slide bar has been slid and (b) whether the lower limit of the temperature range is to be increased or reduced is decided in accordance with a direction in which the second slider on the slide bar has been slid.

With the configuration, a user can change, with intuitive operation, the amounts by which the upper and lower limits are to be changed and whether the upper and lower limits are to be increased or reduced.

In Aspect 7 of the present invention, an image display apparatus in accordance with Aspect 5 further includes a temperature sensor configured to measure the temperature of the environment.

In Aspect 8 of the present invention, an image display apparatus in accordance with Aspect 5 is arranged such that the control section is configured to use, as the temperature of the environment, an average of temperatures obtained from a part of the thermal image which part corresponds to the environment.

In Aspect 9 of the present invention, an image display apparatus in accordance with any of Aspects 1 to 8 is arranged such that: the display section is configured to further display a visible light image of the subject; and the control section is configured to control the display section to display the visible light image such that the visible light image is superimposed on the thermal image.

With the configuration, the visible light image and the thermal image are superimposed; therefore, a user can easily determine the position of the pipe or the like.

An image display method in accordance with Aspect 10 of the present invention is a method of causing an image display apparatus to display a thermal image in which temperature distribution on a subject is represented by colors, the subject including a pipe or the like for a fluid to flow therein, the image display apparatus being portable, the method including the steps of: acquiring an infrared image of the subject captured by an infrared camera; generating, from the infrared image, the thermal image such that the temperature distribution on the subject is represented by colors within a temperature range having upper and lower limits which have been set; and causing the image display apparatus to display the thermal image.

An image display apparatus (in particular, a control section) in accordance with each aspect of the present invention can be realized by a computer. The computer is operated based on (i) a control program for causing the computer to realize the image display apparatus by causing the computer to operate as each section included in the image display apparatus and (ii) a computer-readable storage medium in which the control program is stored. Such a control program and a computer-readable storage medium are included in the scope of the present invention. An image display apparatus in accordance with each aspect of the present invention may be realized as an integrated circuit (IC chip). A chip including the integrated circuit, and the like, are also included in the scope of the present invention.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

10 image display apparatus
10a screen
11 control section
11a first image processing section
11b second image processing section
11c third image processing section
11d display processing section
13 display section
15 touchscreen
16 storage section
16a image display program
16b temperature range data
17 visible-light camera
19 infrared camera
21 communication section
23 interface section
25 temperature sensor

1. An image display apparatus which is portable, comprising:
a display section configured to display a thermal image in which temperature distribution on a subject is represented by colors, the subject including a pipe or the like for a fluid to flow therein; and
a control section configured to control the display section,
the control section being configured to control the display section to display the thermal image such that the temperature distribution on the subject is represented by colors within a temperature range having upper and lower limits that are settable.

2. The image display apparatus according to claim 1, wherein the control section is configured to control the display section to display the thermal image such that the temperature distribution on the subject is represented by variations in at least one of (i) hue, (ii) saturation, and (iii) lightness.

3. The image display apparatus according to claim 1, wherein the control section is configured to control the display section such that, when at least one of the upper and lower limits of the temperature range has been changed, the display section displays the thermal image such that the temperature distribution on the subject is represented by colors within the temperature range in which the at least one of the upper and lower limits has been changed.

4. The image display apparatus according to claim 1, wherein:
the display section includes a screen in which the thermal image is displayed; and
the control section is configured to set the upper and lower limits of the temperature range using, as a reference temperature, a temperature which is obtained from the thermal image and which is indicated at a predetermined position on the screen.

5. The image display apparatus according to claim 4, wherein:
the subject further includes an environment which surrounds the pipe or the like; and
the control section is configured to set the upper and lower limits of the temperature range in accordance with relationship information pre-stored in the image display apparatus, the relationship information being indicative of a relationship between a surface temperature of the pipe or the like and a temperature of the environment.

6. The image display apparatus according to claim 1, wherein:
the control section is configured to control the display section to further display a slide bar such that the slide bar is superimposed on the thermal image, the slide bar being a user interface via which the upper and lower limits of the temperature range are set;
(i) an amount by which the upper limit of the temperature range is to be changed is decided in accordance with an amount by which a first slider on the slide bar has been slid and (ii) an amount by which the lower limit of the temperature range is to be changed is decided in accordance with an amount by which a second slider on the slide bar has been slid; and
(a) whether the upper limit of the temperature range is to be increased or reduced is decided in accordance with a direction in which the first slider on the slide bar has been slid and (b) whether the lower limit of the temperature range is to be increased or reduced is decided in accordance with a direction in which the second slider on the slide bar has been slid.

7. The image display apparatus according to claim 5, further comprising a temperature sensor configured to measure the temperature of the environment.

8. The image display apparatus according to claim 5, wherein the control section is configured to use, as the temperature of the environment, an average of temperatures obtained from a part of the thermal image which part corresponds to the environment.

9. The image display apparatus according to claim 1, wherein:
the display section is configured to further display a visible light image of the subject; and
the control section is configured to control the display section to display the visible light image such that the visible light image is superimposed on the thermal image.

10. A method of causing an image display apparatus to display a thermal image in which temperature distribution on a subject is represented by colors, the subject including a pipe or the like for a fluid to flow therein, the image display apparatus being portable, the method comprising the steps of:
acquiring an infrared image of the subject captured by an infrared camera;
generating, from the infrared image, the thermal image such that the temperature distribution on the subject is represented by colors within a temperature range having upper and lower limits which have been set; and
causing the image display apparatus to display the thermal image.

11. A storage medium storing therein a control program for causing a computer to function as an image display apparatus according to claim 1, the program causing the computer to function as the control section.
